(19) United States
(12) Patent Application Publication
(10) Pub. No.: US 2005/0219171 A1
(43) Pub. Date: Oct. 6, 2005

(54) LED curtain display system and method of making

(75) Inventor: Aidas Gimbutas, Wilmington, DE (US)

Correspondence Address: CONNOLLY BOVE LODGE & HUTZ, LLP, P O BOX 2207, WILMINGTON, DE, 19899, US

(73) Assignee: MAIN LIGHT INDUSTRIES, INC., Wilmington, DE (US)

(21) Appl. No.: 10/708,915

(22) Filed: Mar. 31, 2004

(51) Int. Cl. G09G 3/32

(52) U.S. Cl. 345/82

(57) ABSTRACT

A light-emitting diode (LED) curtain display system includes LED lighting units on at least one LED light string that are attached to a non-rigid curtain. Each LED lighting unit is held within a central opening of a washer. The washer is attached to the reverse face of the curtain fabric, such as with adhesive, so that central opening substantially aligns with a hole formed through the fabric. Each LED lighting unit is visible from the display side of the curtain through its respective hole. The LED lighting unit may be so mounted with or without a covering dome lens. The LED light strings are attached by Ethernet connections to a computer control so that the LED lighting units may be jointly or individually activated.

### FIELD OF THE INVENTION

The present invention pertains to a curtain with a plurality of LED lighting units mounted at desired spaced locations on the curtain providing selectable colors and visual effects controlled by a computer program, and methods for attaching said LED lighting units to the curtain.

### BACKGROUND OF THE INVENTION

Various image display systems have become very popular for use in arenas, in theatres, at special events, and at other public gatherings. These image display systems are used to communicate text and/or stationary or animated images to large audiences to enhance the entertainment or marketing experience.

One popular backdrop for theater and special event lighting is a fiber optic curtain, such as shown in U.S. Pat. No. 5,066,085 to Gimbutas et al. The tips of fiber optic strands are bonded to a curtain fabric. The other ends of the strands are connected to a programmable light source. Before the light source is activated, the curtain has an attractive front face and the fiber optic tips are not visible to an audience. When the light source is activated, bright pin points of light are visible from the fiber optic strand tips. Color and lighting intensity is varied by varying the light source. The present invention seeks to improve upon the fiber optic curtains shown in the Gimbutas et al patent.

Light emitting diodes (“LED”s) are available in the primary light colors of red, green and blue. When current is passed through an LED, energy is released to create light. The color of the emitted light is a function of the materials forming the diode. Generally, an LED is formed from a light-emitting semiconductor material or die mounted on a reflector cup. A cathode lead, an anode lead and a bonding wire are connected to the semiconductor material. Frequently, an LED has a light-transmitting dome or protective cap extending over the light-emitting semiconductor material and reflector cup. LEDs have been inserted into hard-wired boards to make signs or solid display systems.

U.S. Pat. No. 6,016,038, issued to Mueller et al., describes an LED lighting assembly with a pulse width modulated current control where each current-controlled unit is uniquely addressable and capable of receiving intensity and color information from a computer software program. The Mueller et al. invention includes a binary tree network configuration of lighting units called nodes. The disclosed LED lighting assembly contains heat-dissipating housing made out of heat-conductive material. The heat dissipating housing contains two stacked circuit boards holding the power module and the light module. Each light module has at least two, but can contain up to three, primary colors, typically red, blue and/or green that can be combined in different proportions to generate almost any color in the visible spectrum. A computer program creates the LED illumination to provide complex, custom designed images in almost any environment. The present invention seeks to improve this technology by affixing LED nodes at predetermined position and orientation within a curtain to create an LED curtain display system.

U.S. Pat. No. 5,900,850, issued to Bailey et al., discloses an image display system constructed of a plurality of panels formed by flexible straps that extend vertically and horizontally with a plurality of LEDs mounted on the straps at fixed positions to form an LED matrix supported by “upstanding towers” or “column members” of a “conventional truss type” construction. Bailey et al. indicate that their image display system is portable, and capable of being erected on, behind or adjacent to a performance stage. However, this display system requires a support structure, such as towers and beams shown in FIG. 1. The display system can never be retracted or extended during a performance or marketing presentation. Moreover, in the Bailey et al display system the support hardware remains visible to an audience even when the system is not activated. The system thus has an unattractive appearance both when activated and when not activated.

U.S. Pat. No. 6,362,801, issued to Yuhara, is another example of an impractical image display system. Yuhara discloses a flexible net having a mesh portion with the LED display modules attached to the flexible net as pixels. A major disadvantage of this net-type LED display structure is that it is difficult to precisely position the individual LED pixels so that each LED beam projects in unison with other LED beams to create a clean, precise stationary or animated image. Another disadvantage is that the connecting wires and LED mounting hardware remain visible to an audience when the system is not activated for display. The system thus has an unattractive appearance both when activated and when not activated.

U.S. Pat. No. 6,677,918, issued to Yuhara et al., discloses an LED display system comprising a plurality of rigid frames positioned in at least one vertical stack to form a planar vertical display. This display system has the same problems as Bailey et al, in that it must be assembled and disassembled each time, and cannot be retracted or extended once a performance has begun. Additionally, the Bailey et al and Yuhara et al systems cannot completely drape a typical stage or platform with their respective LED displays because of their inherent size limitations. By contrast, a curtain or drape may be designed to variably cover the length and height of a stage or any portion thereof. In addition, Yuhara et al suffers the same appearance drawbacks as Bailey et al and Yuhara.

### BRIEF SUMMARY OF THE INVENTION

In a first aspect, an LED curtain display system includes a non-rigid curtain having a display side and a reverse side that may be mounted or hung for display such as at a special event or a theatrical performance. The curtain is thus retractable and portable, and presents an attractive appearance both when dormant and when illuminated.

The non-rigid curtain preferably is of fabric, which may be treated to be flameproof. The curtain may be formed by joining multiple fabric panels together. The curtain defines one or more holes substantially therethrough and arranged in a desired display pattern. One or more washers each defining a central opening, are fastened to the reverse side of the curtain, with the central openings of the washers substantially aligned with the holes in the curtain in one to one relation. Preferably, the washers are fastened with an adhesive to the reverse side of the curtain. Each washer has an associated LED lighting unit from an LED light string. Each of said LED lighting units is inserted through the central opening of its respective washer, and may be held in place by force fit or by adhesive or other fastening means. The LED portion of the lighting units is visible from the display side of the curtain. Multiple LED lighting units form a visible display pattern on the display side of the curtain when said LED lighting units are activated.

Preferably, the LEDs of the LED light string are capable of illuminating the primary colors of light. The LED curtain display system may be controlled by computer program control through an Ethernet connection. Each LED light string is electrically coupled to a cable connector affixed to said curtain and preferably located at one end of the curtain running vertically. The cable connector joins the LED light strings together and links them by cable through an Ethernet connection and Ethernet power supply to a computer and to a light systems engine adapted for use with LED light strings.

In a second aspect, a method of making an LED curtain display system includes (a) forming a plurality of holes through the curtain fabric; (b) affixing a plurality of washers to the reverse side of the curtain fabric, wherein each washer defines a central opening and the washers are affixed such that the central opening of each washer substantially aligns with one of the holes through the curtain fabric; (c) fitting each LED lighting unit from an LED light string through the central opening of a respective washer in the plurality of washers, so that each of said LED lighting units is visible from the display side of the curtain fabric; (d) connecting said LED light string by male and female connectors to a main connector cable; (e) connecting said main connector cable to an Ethernet power supply, an Ethernet-based hardware controller and a computer containing an LED illumination control program. It is possible to pre-affix the washers to the respective LED lighting units before affixing the washers to the reverse side of the curtain fabric. It is also possible to affix the washers to the reverse side of the curtain before forming holes in the curtain fabric. Preferably, the washers are affixed to the curtain with an adhesive. Optionally, the LED lighting unit may be attached to the washer by force fit or may be attached with an adhesive.

Novel features and advantages of the present invention in addition to those noted above will become apparent to those of ordinary skill in the art from a reading of the following detailed description in conjunction with the accompanying drawings.

### BRIEF DESCRIPTION OF THE DRAWINGS

FIG. 1 is a schematic elevational view showing a curtain comprising an LED display connected to a computer;

FIG. 2 is a fragmental front elevational view showing an LED lighting unit without a covering lens mounted to the curtain;

FIG. 3 is a fragmental rear elevational view of the LED lighting unit of FIG. 2 showing the rear face of the curtain with the LED housing inserted through a supporting washer, and the three-wire 18 AWG cable extending horizontally through the LED housing;

FIG. 4 is a fragmental side elevational view partially in cross section showing one method of attaching an LED lighting unit to a curtain;

FIG. 5 is side elevational view of a modified LED having a dome lens;

FIG. 6 is a schematic view of an Ethernet-based control system for strands of LED lighting units of an LED curtain display system; and

FIG. 7 is a pictorial view of a fiber optic curtain with light projector and controller.

### DETAILED DESCRIPTION OF THE INVENTION

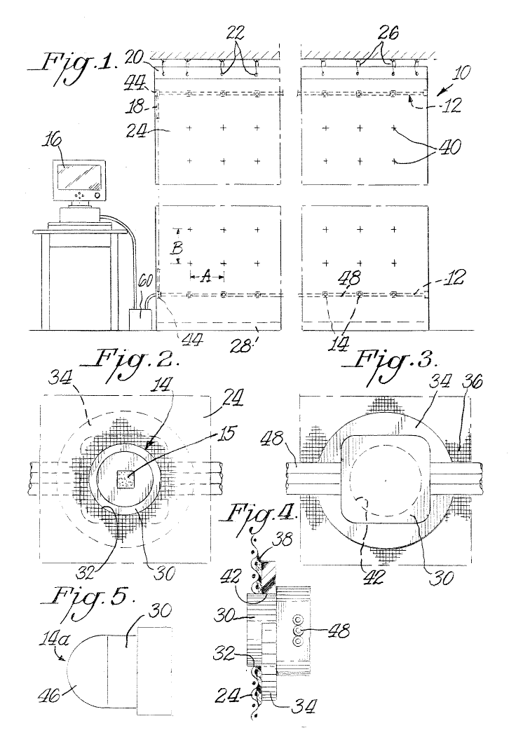

Referring particularly to the drawings, wherein like numerals denote identical parts in the various views, FIG. 1 is a schematic front elevational view showing the display side of an LED curtain display system 10 of the invention. The LED curtain display system 10 has a curtain 24 formed of one or more panels of a fabric or cloth, such as a flame-proofed 100% cotton, black velour material with a weight of 18 to 21 oz. A flame-proofed polyester or cotton polyester blend or denim fabric may also be used. Other fabrics suited to the environment in which the curtain will be installed may be selected. The fabric should be of sufficient weight or thickness to hold the LEDs in desired orientation without pulling or tearing. In addition, other fabric colors may be used. The chosen fabric preferably does not permit light to permeate therethrough so that the curtain has an attractive appearance from its front or display side whether or not the light sources are activated.

Multiple LED light units 14 or nodes are installed in an LED light string 12. The LED light string 12 preferably includes a three-wire 18 AWG cable 48, and the LED light units 14 are spaced apart along the cable 48 to form the LED light string 12. Preferably, multiple LED light units 14 from multiple LED light strings 12 are installed into the LED curtain display system 10. As illustrated in FIG. 1, for example, at least six LED light strings 12 are incorporated into the LED curtain display system 10. As illustrated, multiple rows of LED strings 12 are placed in parallel, horizontal rows with an equal distance A between each lighting unit 14 and an equal distance B between each row. The curtain display system 10 is illustrated in a partially cut away view in FIG. 1. Hence, any number of LED light strings 12 may be incorporated as desired. Moreover, any orientation may be provided, such as in regular rows forming a matrix as shown in FIG. 1, or in regular columns forming a matrix, or in an irregular orientation wherein the LED light strings 12 are curved or partly curved, or wherein the distances A and B are varied.

In FIG. 1, a cable connector 18 runs lengthwise down one end of the curtain 24. Preferably, the cable connector 18 is joined to the reverse side of the curtain 24 by hook and loop fasters (e.g., VELCRO fasteners), but may also be held in place by other fastening means, such as adhesive or a sewn pocket in the hem or selvage of the curtain 24. Each LED light string 12 is provided with an electrical coupling 44 or multi-pin connector for connection to the cable connector 18. The LED light strings 12 are joined together with the cable connector 18 to form an electrical circuit. One end of the cable connector 18, the bottom end in FIG. 1, is joined to a multi-pin connector, which in turn is connected to one or more Ethernet power supplies. The power supply data runs to a Light System Manager that may be programmed by computer 16. The vertically running cable connector 18 delivers the programmable signals from the computer 16 and the Light System Engine that control the LED display from the individual LED light units 14.

Preferably, the LED light strings 12 are iColor™Flex SL light strings manufactured by Color Kinetics, Inc. of Boston, Mass. An alternative LED light string is shown in U.S. Pat. No. 6,461,019. The iColor™Flex SL light strings include LEDs that may be activated to illuminate the three primary colors of light, red, green and blue, such that lighting displays featuring variant colors of the visible spectrum may be programmed. The computer controls the LED display by means of a “Light System Manager”, i.e., an integrated software/hardware product manufactured by Color Kinetics, Inc., of Boston, Mass. The Light System Manager™ is composed of the Light System Composer™, i.e., an illumination control software program, and the Light System Engine™ 70, an Ethernet-based hardware controller that stores and plays a large number of light show effects based on time of day and event scheduling. The Light System Manager 60 may be operatively connected between a computer and the LED light strings 12. Further details of this connection are described below with reference to FIG. 6.

At the top of the curtain 24 a webbing strip 20 with grommets 22 may provide a means for hanging the curtain 24 by straps or hooks 26 to a curtain rod (not shown). At the bottom of the curtain 24 a weighted pocket 28 is provided in the hem.

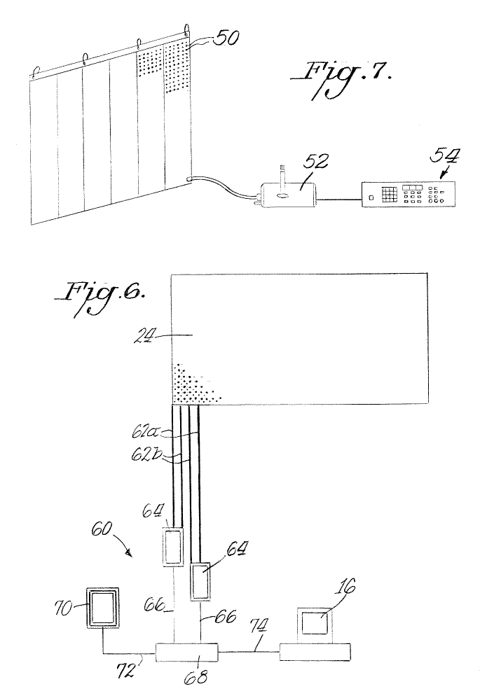

FIG. 2 is a fragmental front elevational view showing the display side of the curtain 24 with an LED lighting unit 14, without a dome lens, attached. The LED lighting unit 14 comprises one or more LEDs 15 within a reflector cup and held within a housing 30. The housing 30 or node is inserted through a predetermined hole 32 formed in curtain 24, and is supported by a washer 34. The washer 34 is affixed (preferably glued) to the reverse side of the curtain fabric 36. A layer of adhesive 38 substantially covers the washer surface adjacent to the reverse surface of the curtain 24 to hold the LED lighting unit 14 in place, as shown in FIG. 4. A preferred washer is a vulcanized fiber-reinforced washer with an adhesive backing that has an outer diameter of 1.25″, an inner diameter of 0.515″ and a thickness of 0.047″. Any washer or grommet that reinforces the hole 32 and retains the LED lighting unit 14 in place can be used. If the washer does not include an integral adhesive backing, a preferred adhesive that may be applied to the washer surface is a styrene-based clear adhesive sealant.

The washer 34 simultaneously (a) reinforces the hole 32 formed in the curtain 24, much like a grommet, and (b) securely holds the LED lighting unit 14 in a desired orientation. When viewed from the display side of the curtain 24, preferably only the reflector cup and LEDs 15 are visible to the audience, and the housing 30, washer 34, and cable 48 remain at the reverse side of the curtain. Preferably, the LED lighting unit 14 is installed such that the LED and associated reflector cup are flush with or nearly flush with the display side surface of the curtain. Most preferably, the LED lighting unit 14 is installed such that the LED and associated reflector cup are substantially parallel with the display side surface of the curtain such that the LED lighting unit will project light outwardly and substantially orthogonally to the display side surface of the curtain.

FIG. 3 is fragmental rear elevational view showing the reverse side of the curtain fabric 36, a washer 34 fastened (e.g., glued) thereto, and the back of the LED housing 30 with its adjacent three-wire 18 AWG cable 48, firmly supported by the washer 34 and force fit (e.g., snapped into a central opening of the washer 34) or glued into place through a central opening defined by the supporting washer 34.

FIG. 4 best illustrates one method of assembling an LED curtain display system 10 according to the invention. First, a plurality of holes 32 are formed into the curtain 24 at predetermined positions 32 as shown in FIG. 1. The holes 32 may be cut with a scissors, punched with an awl, drilled with a hollow drill bit, or other suitable punching means. If a matrix or design is desired, a template (not shown) may be used to direct placement of the holes 32 within the curtain 24. Next, a washer 34 is fastened (e.g., glued with adhesive 38) to the reverse side 36 of the curtain 24 so that the central opening 40 of the washer is aligned with a respective hole 32 in the curtain 24. Alternatively, the washers 34 may be applied to the reverse side of the curtain 24 before the holes 32 are formed therein.

Once the washer 34 is applied and the hole 32 is formed in the curtain 24, the node of the associated LED lighting unit 14 is inserted through the opening 40 in the washer and the hole 32 in the curtain so that the LED housing 30 slightly extends beyond the display side of the curtain fabric 36. The washer 34 surrounds the housing 30 of the LED lighting unit 14 and holds the LED lighting unit 14 into place and in desired orientation with respect to the display side surface of the curtain 24. The housing 30 is thus press-fit within the opening 40 in the washer 34. Alternatively, if so desired, washers 34 can be pre-attached to the housings 30 of LED lighting units 14 on the LED light string 48 before each washer 34 is attached or glued to the reverse side of the curtain 24.

FIG. 5 shows an LED lighting unit 14a having a dome-shaped lens 46 attached to the housing 30. The LED lighting unit 14 shown in FIGS. 2-4 does not include a lens. However, different lighting effects and different curtain display effects can be provided with LED lighting units that incorporate lenses. Thus, a dome-shaped lens 46 or other shaped lenses can be affixed to an LED lighting unit to vary the light refraction as preferred.

After the LED lighting units 14 are securely affixed to the reverse side of the curtain 24, the leader portion of the three-wire 18 AWG cable 48 of the LED light strings 12 are connected by male and female connectors 44 to a vertically running cable connector 18 that is, in turn, connected by cable to an Ethernet power supply and an Ethernet hub, which is in turn connected to a computer 16, completing an electrical circuit. The wire leads from the first LED lighting unit 14 are routed along the inside edge of the curtain and secured. All wire leads from the LED lighting units 14 on a string 12 are gathered and the ends are fitted into a multi-pin connector. The multi-pin connector runs to power supplies with either a multi-pin break out adapter cable or other form of connection.

Referring to FIG. 6, wires 62a, 62b from the LED lighting units 14 extend to an Ethernet power supply 64 that is in turn routed through Ethernet control cable 66 to an Ethernet hub 68. The Ethernet hub 68 is electrically connected through Ethernet control cable 72 to a Light Systems Engine 70, such as available from Color Kinetics. The Ethernet hub 68 is further connected through Ethernet control cable 74 to computer 16 so that programmable data from the Light Systems Control software is transmitted to the hub 68.

With the capability to use a variety of light colors and patterns, the present invention can project light in a matrix or design such as a company or private logo, as well as in any random color display. The illumination patterns may be varied by varying the placement of the LED lighting units 14 within the curtain, and/or by varying the illumination color and intensity of individual LEDs 15 in the LED light strings 12 via computer program control. Thus, static illumination displays and active displays coordinated to music or other timed sequences may be presented. The curtain 24 can be used as a backdrop for the theatrical, special event and entertainment industry or other commercial and domestic use.

It is also within the scope of this invention to combine LED lighting units and fiber optic lighting such as disclosed in U.S. Pat. No. 5,066,085, which patent is incorporated by reference herein, into one curtain display system. Thus, as shown in FIG. 7, the distal ends of one or more fiber optic strands 50 may be affixed, such as with adhesive, to the curtain so that the tips of the fiber optic strands are visible from the display side of the curtain. Then, the proximal ends of such fiber optic strands 50 may be connected to a light source 52 that is in turn connected to a controller 54 or computer.

Many other desirable and advantageous features of this invention will become apparent from the foregoing disclosure. Moreover, while this disclosure explains important aspects of this invention in considerable detail for purposes of illustration, it will be understood by those skilled in the art that many of these details may be varied without departing from the spirit and scope of the invention.

1. An LED curtain display system, comprising:
a) a non-rigid curtain having a display side and a reverse side and defining one or more holes substantially therethrough and arranged in a desired display pattern;
b) one or more washers each defining a central opening, said washers fastened to said reverse side of said curtain, with the central openings of said washers substantially aligned with the holes in said curtain in one to one relation; and
c) one or more LED lighting units contained in an LED light string, each of said LED lighting units inserted through the central opening of a respective washer to form a visible display pattern on the display side of the curtain when said LED lighting units are activated.

2. The LED curtain display system of claim 1 further comprising a cable connector affixed to said curtain and located at one end of the curtain running vertically, wherein said cable connector joins said LED light strings together.

3. The LED curtain display system of claim 2, wherein said LED light string is programmably connected to a computer through an Ethernet connection.

4. The LED curtain display system of claim 3, further comprising a means for hanging the curtain.

5. The LED curtain display system of claim 1, wherein the one or more washers are fastened to the reverse side of the curtain with adhesive.

6. The LED curtain display system of claim 5, wherein the adhesive is a styrene-based clear adhesive.

7. The LED curtain display system of claim 5, wherein the washer has a front face and a rear face, and said front face is fastened to the reverse side of the curtain, and said rear face is adhesively attached to a housing of an LED lighting unit.

8. The LED curtain display system of claim 1, wherein the curtain is formed of a material selected from the group consisting of: cotton, polyester, denim, polyester blends, and cotton blends.

9. The LED curtain display system of claim 1, wherein the curtain is formed from two or more panels joined together.

10. The LED curtain display system of claim 1 wherein the LED light units are present in a plurality and are arranged in substantially parallel rows and columns to form a matrix.

11. The LED curtain display system of claim 3 wherein the LED display is programmably controllable to vary the colors emitted by each individual LED lighting unit over time.

12. The LED curtain display system of claim 1, wherein at least one of the LED lighting units has an associated a dome lens that extends through the respective hole in the curtain.

13. The LED curtain display system of claim 1, further comprising one or more fiber optic strands each having a proximal end and a distal end, wherein the distal ends of said fiber optic strands are affixed to the curtain and the proximal ends of said fiber optic strands are affixed to a light source.

14. A method of making an LED curtain display system, comprising the following steps:
a) providing a curtain fabric having a display side and a reverse side;
b) forming a plurality of holes through the curtain fabric;
c) affixing a plurality of washers wherein each washer defines a central opening to the reverse side of said curtain such that the central opening of each washer substantially aligns with one of the holes through the curtain fabric;
d) providing a plurality of LED lighting units on an LED light string and fitting each LED lighting unit through the central opening of a respective washer in the plurality of washers, so that each of said LED lighting units is visible from the display side of the curtain fabric;
e) connecting said LED light string by male and female connectors to a main connector cable;
f) connecting said connector cable to a power supply; and
g) connecting said connector cable either directly or indirectly to a computer containing an LED illumination control program and an Ethernet-based hardware controller.

15. The method of claim 13, wherein each washer is affixed to the curtain fabric with an adhesive.

16. The method of claim 13, wherein each LED lighting unit has a housing and said housing is affixed to a respective washer with an adhesive.

17. The method of claim 13, wherein the washer is pre-affixed to the LED lighting unit and then glued to the reverse side of said curtain fabric such that the central opening of the washer substantially aligns with the hole through the curtain fabric to create a reinforced hole within said curtain fabric.

18. The method of claim 13, wherein a plurality of LED light strings is installed onto the curtain fabric.

19. The method of claim 18, wherein the plurality of holes through the curtain fabric form a matrix, and the LED light units are affixed in said matrix such that each LED light string forms a row.
